(19) United States
(12) Patent Application Publication
(10) Pub. No.: US 2014/0223326 A1
(43) Pub. Date: Aug. 7, 2014

(54) APPARATUS AND METHODS FOR CO-LOCATED SOCIAL INTEGRATION AND INTERACTIONS

(71) Applicant: INTERNATIONAL BUSINESS MACHINES CORPORATION, Armonk, NY (US)

(72) Inventors: Kiran Mantripragada, Sao Paulo (BR); Lucas V. REAL, Sao Paulo (BR); Nicole SULTANUM, Sao Paulo (BR)

(73) Assignee: INTERNATIONAL BUSINESS MACHINES CORPORATION, Armonk, NY (US)

(21) Appl. No.: 13/760,554

(22) Filed: Feb. 6, 2013

(51) Int. Cl. G06F 3/01

(52) U.S. Cl. CPC G06F 3/01
USPC 715/744

(57) ABSTRACT

Devices and methods for co-located social interaction include one or more screens arranged to provide a substantially continuous, outward-facing display; a proximity sensor configured to detect the presence of users near the screen; a recognition sensor configured to gather identifying information about a detected user and to determine an identity of the detected user by matching the identifying information in a user database; an input sensor configured to receive user input; and a control module configured to control information displayed on the one or more screens based on a user's identity, the presence of other users nearby, and input provided by the user.

### BACKGROUND

1. Technical Field

The present invention relates to user interfaces and, more particularly, to public social interfaces.

2. Description of the Related Art

With the growth of technologies such as multi-touch displays, the possibilities for public user-interfaces have expanded. Such interfaces allow users in public places to rapidly access site-specific information, such as directions and information about local businesses, in an intuitive way.

The social applications of these interfaces have been limited so far. In particular, existing interfaces fail to provide for interaction between non-acquainted, co-located individuals. This is due in part to the limitations of the existing interface designs, which make shared use of an interface difficult.

### SUMMARY

An interface device is shown that includes one or more screens arranged to provide a substantially continuous, outward-facing display; a proximity sensor configured to detect the presence of users near the interface device; a recognition sensor configured to gather identifying information about a detected user and to determine an identity of the detected user by matching the identifying information in a user database; an input sensor configured to receive user input; and a control module configured to control information displayed on the one or more screens based on a user's identity, the presence of other users nearby, and input provided by the user.

A further interface device is shown that includes one or more screens arranged to provide a substantially continuous, outward-facing display that forms a circle; a proximity sensor configured to detect the presence of users near the interface device; a recognition sensor configured to gather identifying information about a detected user and to determine an identity of the detected user by matching the identifying information in a user database, wherein said identifying information comprises wireless signals from a detected user's personal devices; an input sensor configured to receive user input; and a control module configured to control information displayed on the one or more screens based on a user's identity, the presence of other users nearby, and input provided by the user to display a location of at least one nearby user in relation to the identified user's position.

A method for facilitating co-located social interaction is shown that includes detecting a first user's presence at an interface device that has one or more screens arranged to provide a substantially continuous, outward-facing display; collecting identifying information about the first user from one or more recognition sensors; matching the collected identifying information to a first user's profile in a user database using a processor; and displaying an avatar of the first user on the display in relation to other users at the interface device.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of a user interacting with an interface device in accordance with the present principles;

FIG. 2 is a diagram illustrating different embodiments of an interface device in accordance with the present principles;

FIG. 3 is a diagram of a control module for an interface device in accordance with the present principles;

FIG. 4 is a block/flow diagram illustrating a method for promoting social interaction using an interface device in accordance with the present principles; and

FIG. 5 is a diagram of a multi-device, multi-user environment in accordance with the present principles.

### DETAILED DESCRIPTION OF PREFERRED EMBODIMENTS

The present principles provide a public interface terminal that is well suited for simultaneous use by multiple co-located individuals. Previous attempts at public interactive displays are limited in that they have provided only flat surfaces. As a result, it is difficult for users to use the displays simultaneously, as each user occupies a much larger amount of space than is actually needed to interact. Because strangers will be hesitant to infringe on a user's personal space, the flat design imposes a limit on the practical usable surface area of the interface.

Embodiments of the present principles provide an interface on a surface that faces in 360 degrees. As will be described in detail below, this surface allows multiple users to comfortably use the interface in a way that allows for more users per unit surface area than does a purely planar surface. Additionally, specific social interaction functions are incorporated to encourage and facilitate interaction between non-acquainted individuals.

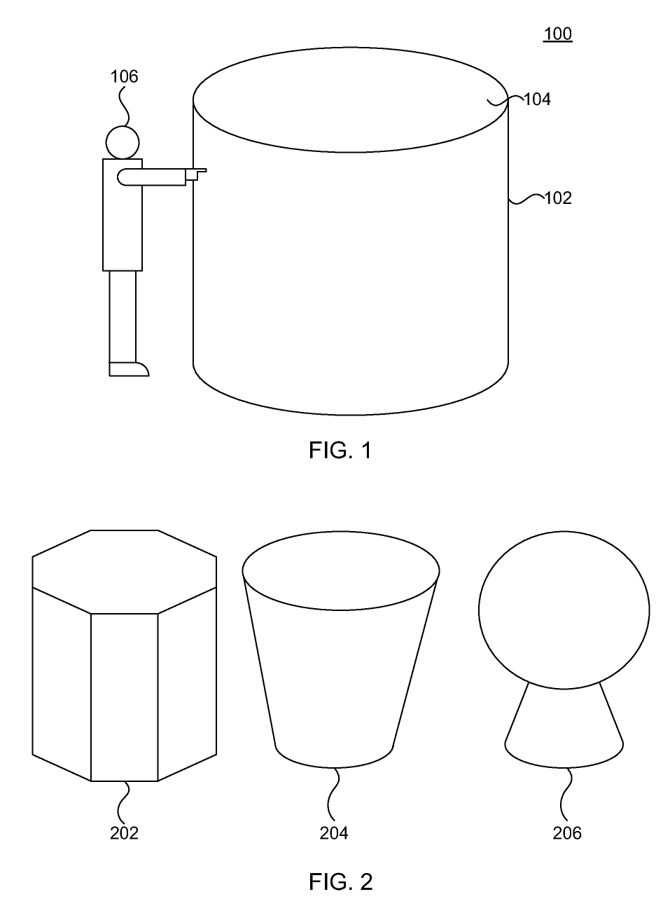

Referring now to the drawings in which like numerals represent the same or similar elements and initially to FIG. 1, an exemplary interface display totem 100 is shown. A cylindrical touch-screen surface 102 is positioned around a structural area 104. The structural area 104 provides support and stability to the surface 102 and may further house control and communication equipment to control the surface 102. A user 106 interacts with the surface 102 by touching the surface 102 with bare skin, e.g., a finger. The surface may be formed from any suitable touch interface, including but not limited to resistive, capacitive, optical imaging, and multi-touch screens. The use of multi-touch screens allows multiple users 106 to interact with the surface 102 simultaneously, providing an opportunity for social interaction.

The totem 100 may be placed in a public space and exposed to crowds. This may include, but is not limited to, a plaza, museums, concert halls, airports, train stations, public event spaces, etc. The totem 100 may be configured to detect the presence of individuals by, e.g., cameras, pressure sensing, thermal imaging, proximity sensors, depth sensors, etc. The totem 100 may incorporate recognition technologies using, e.g., face recognition or biometrics. The totem 100 may also be sensitive to personal devices carried by the users 106 such as, e.g., a Bluetooth®-enabled smartphone, to provide a further recognition factor. Users 106 may interact with the totem 100 through physical manipulation of the screen 102 or through indirect methods. For example, the totem 102 may use visual tracking of user movements to recognize gestures.

Upon sensing and recognition of a user 106, the totem 100 may display a social map on surface 102, representing the user 106 as an avatar and showing other avatars for the people nearby. The totem 100 may track information regarding the users and may provide social functions based on that information. The totem 100 may further be one in a network of totems 100, sharing user information between them. As the user 106 moves, the totems 100 may update the user's avatar and connections. This may be particularly useful in, for example, a large festival where the totems 100 would provide intuitive meeting points and facilitate users 106 in meeting and making plans with their friends.

Referring now to FIG. 2, other shapes for totem 100 are shown. Totem 202 is formed from a set of flat panels arranged in an octagon. It should be recognized that any number of such flat panels may be arranged contiguously to provide an arbitrary number of facing sides. Totem 204 shows a surface formed in a conical shape. As with the cylindrical totem 100, the conical totem 204 provides a smooth surface, without image distortion, but may provide a superior aesthetic. Totem 206 shows a spherical surface. In the case of a spherical totem 206, distortion correction in software may be needed to maintain a coherent visualization, due to the non-Euclidean geometry of the surface.

It should be recognized that the totem shapes described herein are intended to be illustrative only, and that those having ordinary skill in the art would be able to devise other shapes that fall within the scope of the present principles. Furthermore, although it is specifically contemplated that the screen 102 will provide a full 360 degrees of display, the present principles may also be implemented with a less-than-full circumference of display or with entirely flat displays. For example, the screen 102 may be formed from individual flat panels, as in totem 202. In such a case, it is to be expected that there will be some surface area lost to bezels as well as gaps formed by the angular arrangement of rectilinear edges. Furthermore, the screen 102 may be substantially less than 360 degrees, for example if the totem 100 is to be integrated into existing architectural features. If the totem 100 were to be formed around a corner, it might have only 270 degrees of available screen surface. Embodiments of the present principles may also include standalone, flat displays.

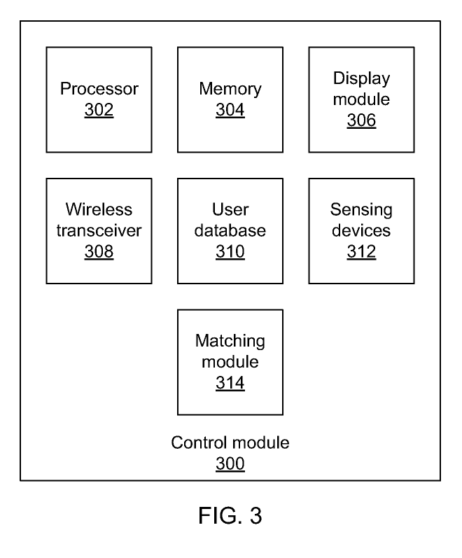

Referring now to FIG. 3, an exemplary control module 300 for totem 100 is shown. As noted above, the control module 300 may be housed within the support structure 104, or it may be implemented remotely, with display and input information being transmitted wirelessly or through a wired connection. A processor 302 and memory 304 control the operations of the totem 100. In particular, a display module 306 controls the information displayed on the surface 102. The display module 306 arranges avatars and other information in a visual field based on the position of the user 106 relative to the totem 100. The display module 306 also performs whatever corrections are necessary to address distortions that result from the geometry of the surface 102.

Sensing devices 312 provide position and identity information regarding users 106. These sensing devices may include, e.g., touch sensitivity built into the screen 102, cameras, pressure sensors, microphones, proximity sensors, motion sensors, biometric sensors, etc. The sensing devices 312 may provide identity information as well as positioning information. The identity information may be determined through facial recognition or other biometrics. Further identity information may be provided by wireless transceiver 308, which can sense nearby devices. The wireless transceiver 308 may be sensitive to one or more types of wireless communication including, e.g., 802.11 signals, Bluetooth®, radio-frequency identification, ZigBee®, etc. The information provided by wireless transceiver 308 and sensing devices 312 may be used to generate an identity profile for the user 106. That identity profile may be compared to user database 310 to call up a user profile for the user 106.

The user database 310 may be used to store user preferences, identity information, and social network information such as connections to acquaintances and friends. The user database 310 may be based on an existing social network, allowing users 106 to link their identities to their accounts on such a network. Alternatively, the database 310 may be a private database that includes users based on their status or function. For example, the user database 310 may include a list of all attendees of a conference, which would make it a useful networking tool.

One contemplated use for the totems 100 is to promote social interaction between users 106. Toward this end, a matching module 314 identifies users' similarities based on collected information and personal information stored in user database 310. Such similarities may include, e.g., nationality, personal tastes, plans for the day, friends in common, etc. The matching module 314 may also take into account user matching preferences. For example, if a user 106 expresses interest in finding company for a comedy show, the totem 100 may display an invitation to other users 106 who have an interest in comedy.

Matching between users in the matching module 314 may be performed in a number of ways. For example, the matching may be as simple as a vector distance function, where an array of attributes from each co-located user may be represented as a point in an n-dimensional space. A distance value may be computed between the points representing the users in said n-dimensional space, and the distance value may be used as a matching score. A smaller distance indicates a greater similarity between the attributes of the users and, hence, a better match. The matching module 314 may then determine whether the matching is good enough to be worth displaying to the users. This may be performed by determining whether the match score is within a predefined threshold. The strength of a connection can be represented visually by display module 306. For example, a weak connection may be displayed as a thin, grey line between the users in question, whereas a strong connection may be shown as being bright and bold. Similarly, different colors may be used to represent connections based on particular categories of attributes.

The user may also specify how display module 306 represents matches determined by matching module 314. This information may be stored, for example, in user database 310 and may specify categories of attributes which the user finds more or less relevant. In one exemplary embodiment, the user specifies a weighting factor for attributes relating to professional interests. The matching module 314 uses this weighting factor in determining the final matching score before a comparison to a threshold, thereby filtering the results according to the user's desires.

Once a match has been established and displayed, the users have the option of providing an input that is recognized by sensing devices 312. The user is able to obtain additional information about the match and, in particular, determine what attributes formed the strongest bases for the match. The user also has the option to create a connection and communicate through the system. For co-located users this can be as simple as saying hello, but it should be recognized that connections may be formed between users at different terminals entirely. In this case, forming a connection may include transmitting a picture or video of the user, voice information, text information, etc. The matching module 314 may further weight match scores according to user proximity, depending on the desired effects of the application.

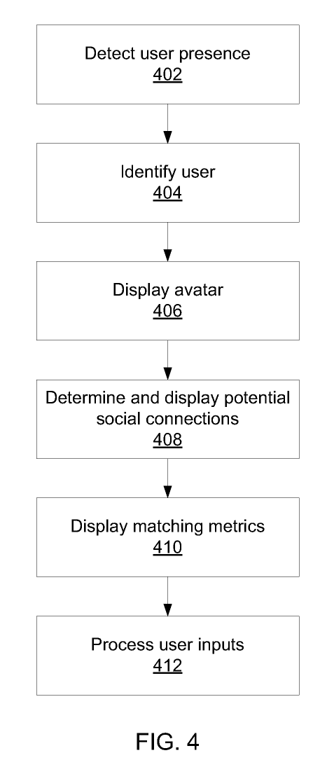

Referring now to FIG. 4, a method for social networking using a totem 100 is shown. Block 402 detects the presence of a user 106 using, e.g., sensing devices 312. As noted above, this detection may include determining the user's position relative to the totem 100, but it should be recognized that the detection of position need not be limited to the immediate vicinity of the totem 100. For example, once a user has been located, that user's position may be tracked within an area of awareness if the sensing devices 312 have a sufficiently long range or are distributed through a venue. To use the example of a conference, a user 106 who is detected by the totem 100 may be tracked through presentations and rooms, allowing their colleagues to locate them.

Block 404 identifies the detected user 106. This identification may be based on an explicit authentication by the user or may be performed automatically based on facial/biometric recognition or wireless device sensing. In one particular embodiment it is contemplated that the user 106 will perform an initial manual authentication, but that subsequent identifications will be able to match the user 106 to an entry in the user database 310.

Block 406 displays an avatar for the user on screen 102, along with the avatars of other users and any other pertinent or requested information. Block 406 may furthermore provide map or geographical information, particularly in a venue that has multiple totems 100, to relate the position of the users 106 to real-world landmarks. Block 408 determines and displays potential social connections between the users 106. This determination may include matching users based on their similarities and shared interests. Block 410 may further display metrics that reflect the users' similarities, permitting visual comparison of the users' respective profiles. For example, the match may be represented as a percentage score, as a heat map, or as a set of icons representing compatibilities or incompatibilities. Block 412 then allows users to enter inputs and interact with the displayed data via sensing devices 312. For example, the user 106 can accept or refuse suggested connections.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

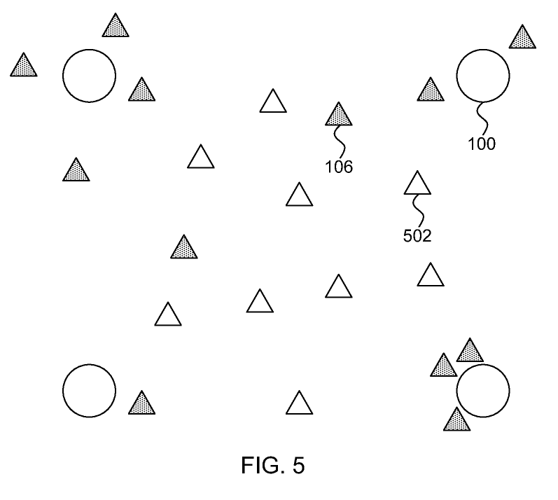

Referring now to FIG. 5, a multiple-totem installation is shown with users. Several totems 100 are placed in a high-traffic area. Identified users 106 are present near the totems 100, but may also be elsewhere in the space. As noted above, such users may be located in the vicinity of a totem 100, or may have been identified in the surrounding area. Unidentified users 502 are also present. These users 502 may have their locations registered by the totem, even if sufficient identifying information is unavailable or if they do not exist in the user database 310. The unidentified users 502 may be displayed on the totem's map of nearby users or they may be omitted for greater ease in reading the information. The user database 310 may also track information for users who have not yet been positively identified. This may be as simple as tracking their positions to provide an accurate map of the area and the people in it, or it may be as detailed as pre-existing profile accessed from existing social media networks.

Having described preferred embodiments of an apparatus and methods for co-located social integration and interactions (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1-13. (canceled)

14. A method for facilitating co-located social interaction, comprising:
detecting a first user's presence at an interface device that has one or more screens arranged to provide a substantially continuous, outward-facing display;
collecting identifying information about the first user from one or more recognition sensors;
matching the collected identifying information to a first user's profile in a user database using a processor; and
displaying an avatar of the first user on the display in relation to other users at the interface device.

15. The method of claim 14, further comprising:
comparing the first user's profile to other profiles in the user database to find a match; and
suggesting a connection between the first user and a matched second user.

16. The method of claim 15, further comprising receiving a user input to accept or reject the suggested connection using an input sensor.

17. The method of claim 16, wherein the input sensor includes a touch sensor incorporated in the one or more screens.

18. The method of claim 16, wherein the input sensor includes a camera configured to recognize user gestures.

19. The method of claim 14, wherein the identifying information comprises wireless signals received from a user's personal devices.

20. The method of claim 14, wherein the display extends 360 degrees around an internal point, such that multiple users can access said display.

21. (canceled)
